(19) United States
(12) Patent Application Publication
(10) Pub. No.: US 2012/0262752 A1
(43) Pub. Date: Oct. 18, 2012

(54) IMAGE FORMING APPARATUS, APPLICATION CONTROL METHOD, AND NON-TRANSITORY COMPUTER-READABLE RECORDING MEDIUM ENCODED WITH APPLICATION CONTROL PROGRAM

(75) Inventor: Shunsaku KYOO, Kawabe-gun (JP)

(73) Assignee: Konica Minolta Business Technologies, Inc., Chiyoda-ku (JP)

(21) Appl. No.: 13/447,082

(22) Filed: Apr. 13, 2012

(30) Foreign Application Priority Data
Apr. 18, 2011 (JP) 2011-091846

(51) Int. Cl. G06K 15/02; G06F 3/12

(52) U.S. Cl. 358/1.14; 358/1.15

(57) ABSTRACT

An image forming apparatus having a plurality of application programs installed therein includes a related application starting portion and an integrated display portion. The related application starting portion is operable, in response to a start of a reference application program which is an arbitrary one of the plurality of application programs, to start any related application program that is of the same type as the reference application program among the remaining application programs. The integrated display portion displays, in a selectable manner, a first screen which is output as the reference application program is executed and a second screen which is output as the related application program is executed.

This application is based on Japanese Patent Application No. 2011-091846 filed with Japan Patent Office on Apr. 18, 2011, the entire content of which is hereby incorporated by reference.

### BACKGROUND OF THE INVENTION

1. Field of the Invention

The present invention relates to an image forming apparatus, an application control method, and a non-transitory computer-readable recording medium encoded with an application control program. More particularly, the present invention relates to an image forming apparatus having a plurality of application programs installed therein, an application control method executed by the image forming apparatus, and a non-transitory computer-readable recording medium encoded with an application control program for causing a computer to execute the application control method.

2. Description of the Related Art

A multi-function peripheral (hereinafter, referred to as an “MFP”) may be connected to a network such as a local area network (LAN) to cause it to communicate with a server which is connected to the LAN or the Internet, so that the MFP can use a service provided from the server. For example, Japanese Patent Application Laid-Open No. 2009-093208 discloses a pull-printing system in which print data is transmitted from a personal computer (hereinafter, referred to as a “PC”) to a print server for storage, and then an MFP downloads the print data stored in the print server for printing. In this system, the MFP has installed therein an application program for communicating with a print server. In the case where a plurality of print servers are connected to a network, a plurality of application programs corresponding respectively to the print servers are installed in the MFP.

Further, if a browsing program is installed in an MFP, the MFP can use a service, for example “software as a service (SaaS)”, which is provided from a Web server connected to the Internet. Some of SaaS products provide a pull-printing service. In this case, a Web server functions in a similar manner as the aforementioned print server.

In the case where two or more application programs are installed in an MFP to allow the MFP to use more than one service of the same type, however, one application program has to be executed for each of the plurality of services. For example, in order to download two or more pieces of print data stored in different print servers, a plurality of application programs need to be executed one after another, requiring troublesome operations.

### SUMMARY OF THE INVENTION

An aspect of the present invention provides an image forming apparatus having a plurality of application programs installed therein, the apparatus including: a related application starting portion operable, in response to a start of a reference application program which is an arbitrary one of the plurality of application programs, to start at least one related application program which is of the same type as the reference application program among the remaining application programs; and an integrated display portion to display a first screen and a second screen in a selectable manner, the first screen being output as the reference application program is executed, the second screen being output as the related application program is executed.

Another aspect of the present invention provides an application control method performed by an image forming apparatus having a plurality of application programs installed therein, the method including the steps of in response to a start of a reference application program which is an arbitrary one of the plurality of application programs, starting at least one related application program which is of the same type as the reference application program among the remaining application programs; and displaying a first screen and a second screen in a selectable manner, the first screen being output as the reference application program is executed, the second screen being output as the related application program is executed.

A further aspect of the present invention provides a non-transitory computer-readable recording medium encoded with an application control program performed by a computer which controls an image forming apparatus having a plurality of application programs installed therein, the program causing the computer to perform the steps of: in response to a start of a reference application program which is an arbitrary one of the plurality of application programs, starting at least one related application program which is of the same type as the reference application program among the remaining application programs; and displaying a first screen and a second screen in a selectable manner, the first screen being output as the reference application program is executed, the second screen being output as the related application program is executed.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 schematically shows an information processing system according to an embodiment of the present invention;

FIG. 2 is a perspective view of an MFP;

FIG. 3 is a block diagram showing, by way of example, the hardware configuration of the MFP;

FIG. 4 is a plan view showing an example of an operation panel;

FIG. 5 is a block diagram schematically showing the functions of a CPU included in the MFP, together with information stored in an EEPROM;

FIG. 6 shows an example of an application table;

FIG. 7 shows an example of an authentication table;

FIG. 8 shows an example of an application selecting screen;

FIG. 9 shows an example of an integrated screen;

FIG. 10 shows another example of the integrated screen; and

FIGS. 11 and 12 show a flowchart illustrating an example of the flow of an application control process.

### DESCRIPTION OF THE PREFERRED EMBODIMENTS

A preferred embodiment of the present invention will be described below in conjunction with the drawings. In the following description, the same or corresponding parts are denoted by the same reference characters. Their names and functions are also the same. Thus, a detailed description thereof will not be repeated.

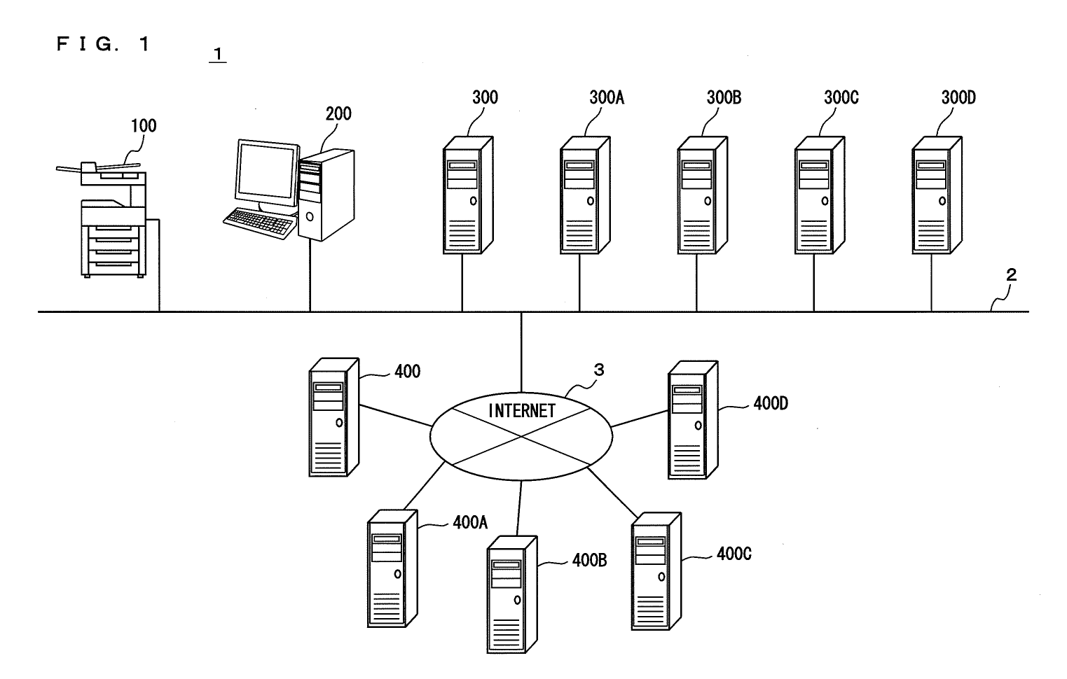

FIG. 1 schematically shows an information processing system according to an embodiment of the present invention. Referring to FIG. 1, an information processing system 1 includes an MFP 100, a PC 200, and servers 300 and 300A to 300D, which are each connected to a network 2, and Web servers 400 and 400A to 400D, which are each connected to the Internet 3. MFP 100 as an example of an image forming apparatus has a plurality of functions such as the scanner function, function as a printer, copying function, and facsimile transmitting/receiving function.

Network 2 is a local area network (LAN), which is connected to the Internet 3 via a gateway, thereby allowing MFP 100 to communicate with PC 200 and servers 300 and 300A to 300D, each connected to network 2, and with Web servers 400 and 400A to 400 D, each connected to the Internet 3. The protocol used in communications between MFP 100 and each of Web servers 400 and 400A to 400D may be hypertext transfer protocol (HTTP), although it is not restricted thereto. Network 2 is not necessarily the LAN; it may be the Internet, a wide area network (WAN), public switched telephone networks (PSTN), and the like.

MFP 100 has a browsing program installed therein. A browser function is implemented as MFP 100 executes the browsing program. For example, when a user designates a uniform resource locator (URL) of a Web page stored in Web server 400, MFP 100 transmits to Web server 400 a request to transmit the Web page specified by the URL, and receives and displays the Web page transmitted from Web server 400 in response to the request. Here, a Web page is text data which is written in a markup language such as hypertext markup language (HTML) or extensible markup language (XML). Hereinafter, the process performed by MFP 100 to download and display a Web page will be referred to as a “browsing process”.

Web servers 400 and 400A to 400D each provide various services. Web servers 400 and 400A to 400D each store Web pages for providing the services, and transmit a Web page to MFP 100 in response to a request from MFP 100 which has the browser function. Some of the Web pages transmitted from Web servers 400 and 400A to 400D include various commands which use application program interfaces (APIs) of MFP 100. Further, Web servers 400 and 400A to 400D each have a common gateway interface (CGI) and execute a CGI command in response to a request from MFP 100 having the browser function. For example, in the case where Web servers 400 and 400A to 400D each function as a print server, it executes a CGI command in response to a request from MFP 100, to transmit to MFP 100 print data which is associated with the user who operates MFP 100. Further, in the case where Web servers 400 and 400A to 400D each function as a file server, it executes a CGI command in response to a request from MFP 100, to receive data transmitted from MFP 100 and store the received data in a storage device.

While MFP 100 is described as an example of the image forming apparatus in the present embodiment, the image forming apparatus is not limited to MFP 100; it may be a printer, facsimile machine, or any other device having an image forming function.

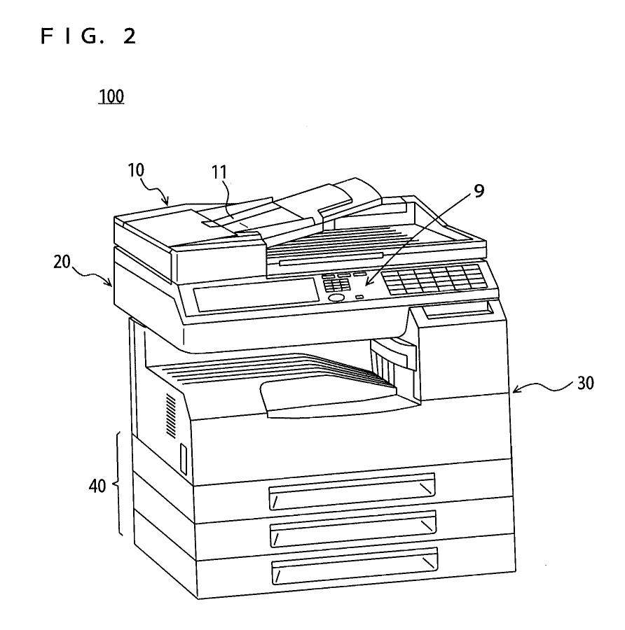

FIG. 2 is a perspective view of an MFP. Referring to FIG. 2, MFP 100 includes an operation panel 9, an automatic document feeder (ADF) 10, a document reading portion 20, an image forming portion 30, and a paper feeding portion 40.

ADF 10 automatically feeds a plurality of documents set on a document feed tray 11, one by one, to a predetermined document reading position set on a platen glass of document reading portion 20, and outputs the document, the image of which has been read by document reading portion 20, onto a document output tray. Document reading portion 20 includes an optical source which irradiates a document placed on the document reading position with light and a photoelectric conversion element which receives light reflected from the document, and scans a document image having a size corresponding to that of the document. The photoelectric conversion element converts the received light into image data made up of electric signals, to store the data in a memory or output the same to image forming portion 30.

Image forming portion 30 forms an image using well-known electrophotography. Image forming portion 30 performs various kinds of data processing such as shading compensation on image data received from document reading portion 20 and, on the basis of the processed image data, forms an image on a sheet of paper fed by paper feeding portion 40. Paper feeding portion 40 feeds a sheet of paper, stored in a paper feed tray, to image forming portion 30.

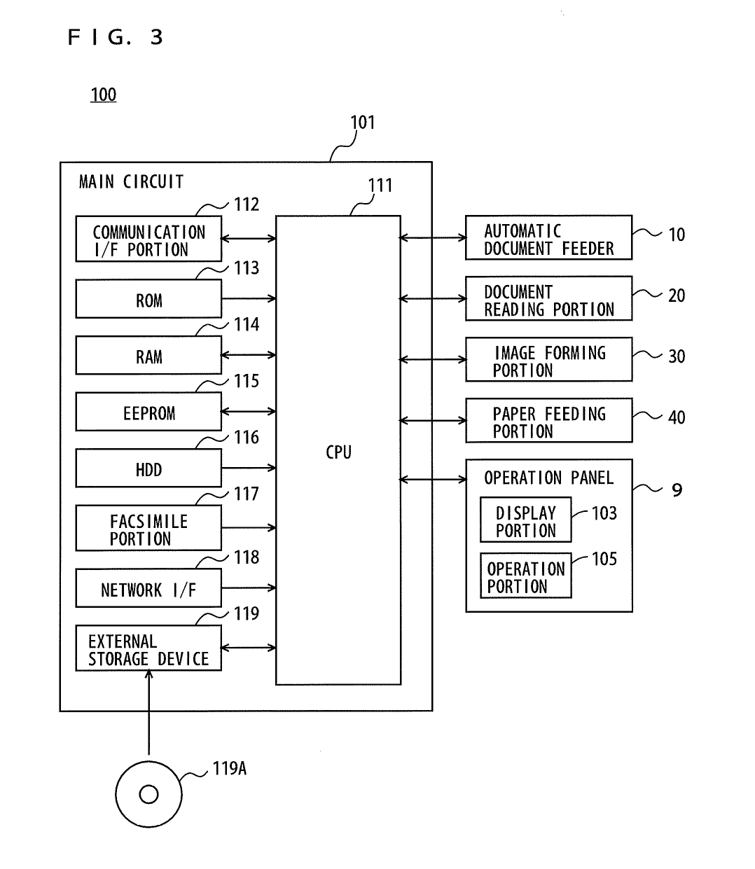

FIG. 3 is a block diagram showing, by way of example, the hardware configuration of the MFP. Referring to FIG. 3, MFP 100 includes: a main circuit 101; ADF 10; document reading portion 20; image forming portion 30; paper feeding portion 40; and operation panel 9 serving as a user interface.

Main circuit 101 includes a CPU 111, a communication interface (I/F) portion 112, a read only memory (ROM) 113, a random access memory (RAM) 114, an electrically erasable and programmable ROM (EEPROM) 115, a hard disk drive (HDD) 116 as a mass storage, a facsimile portion 117, a network interface (I/F) 118, and an external storage device 119 on which a compact disc ROM (CD-ROM) 119A may be mounted. CPU 111 is connected with ADF 10, document reading portion 20, image forming portion 30, paper feeding portion 40, and operation panel 9, and is responsible for overall control of MFP 100.

ROM 113 stores a program executed by CPU 111 and data necessary for execution of the program. RAM 114 is used as a work area when CPU 111 executes a program.

Communication I/F portion 112 is an interface for connecting MFP 100 to other devices through a serial communication cable. It is noted that they may be connected in a wired or wireless manner.

Facsimile portion 117 is connected to public switched telephone networks (PSTN), and transmits facsimile data to or receives facsimile data from the PSTN. Facsimile portion 117 stores the received facsimile data in HDD 116, or outputs it to image forming portion 30. Image forming portion 30 prints the facsimile data received by facsimile portion 117 on a sheet of paper. Further, facsimile portion 117 converts the data stored in HDD 116 to facsimile data, and transmits it to a facsimile machine connected to the PSTN.

Network I/F 118 is an interface for connecting MFP 100 to network 2. CPU 111 is capable of communicating via network I/F 118 with PC 200 and servers 300 and 300A to 300D, and with Web servers 400 and 400A to 400D which are connected to the Internet 3.

External storage device 119 is mounted with CD-ROM 119A. CPU 111 is capable of accessing CD-ROM 119A via external storage device 119, and loading a program, stored in CD-ROM 119A, into RAM 114 for execution. It is noted that the program executed by CPU 111 is not restricted to the program stored in CD-ROM 119A. It may be a program stored in another storage medium, or in HDD 116. Still alternatively, it may be a program written into HDD 116 by another computer connected to network 2 via network I/F 118.

It is noted that the storage medium for storing a program is not restricted to CD-ROM 119A. It may be an optical disc (magneto-optical (MO) disc, mini disc (MD), digital versatile disc (DVD)), an IC card, an optical card, or a semiconductor memory such as a mask ROM, an erasable programmable ROM (EPROM), an EEPROM, or the like.

As used herein, the “program” includes, not only the program which CPU 111 can execute directly, but also a source program, a compressed program, an encrypted program, and others.

Operation panel 9 is provided on an upper surface of MFP 100, and includes a display portion 103 and an operation portion 105. Display portion 103 is a display such as a liquid crystal display or an organic electro-luminescence display (ELD), and displays an instruction menu for a user, information about acquired display data, and others. Operation portion 105 accepts an operation by a user to output the accepted operation to CPU 111.

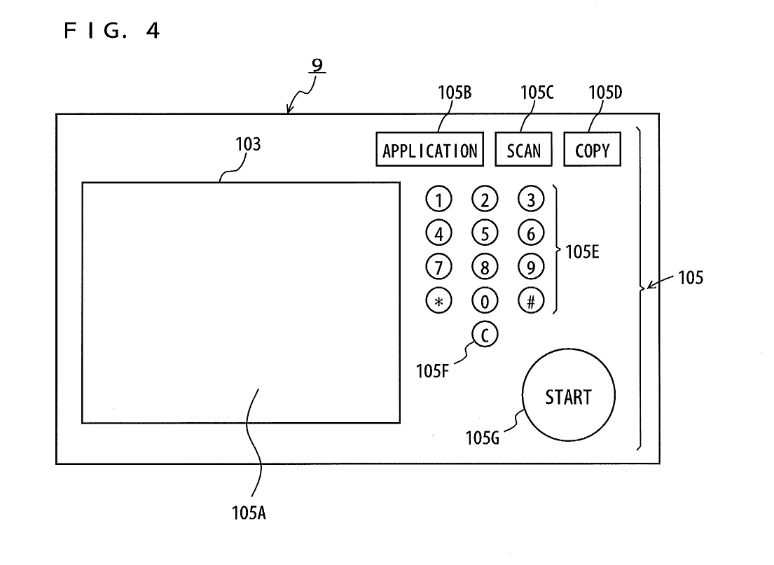

FIG. 4 is a plan view showing an example of an operation panel. Referring to FIG. 4, operation portion 105 includes: a touch panel 105A overlaid on display portion 103; an application key 105B to which an operation of instructing execution of a browsing process is assigned; a scan key 105C to which an operation of instructing execution of a scan process is assigned; a copy key 105D to which an operation of instructing execution of a copy process is assigned; a ten-key pad 105E; a clear key 105F for cancelling the input content; and a start key 105G. Touch panel 105A, which is made of a transparent member, is overlaid on display portion 103. When a user touches touch panel 105A with his/her finger, touch panel 105A detects the touched position as a designated position, and outputs the designated position to CPU 111.

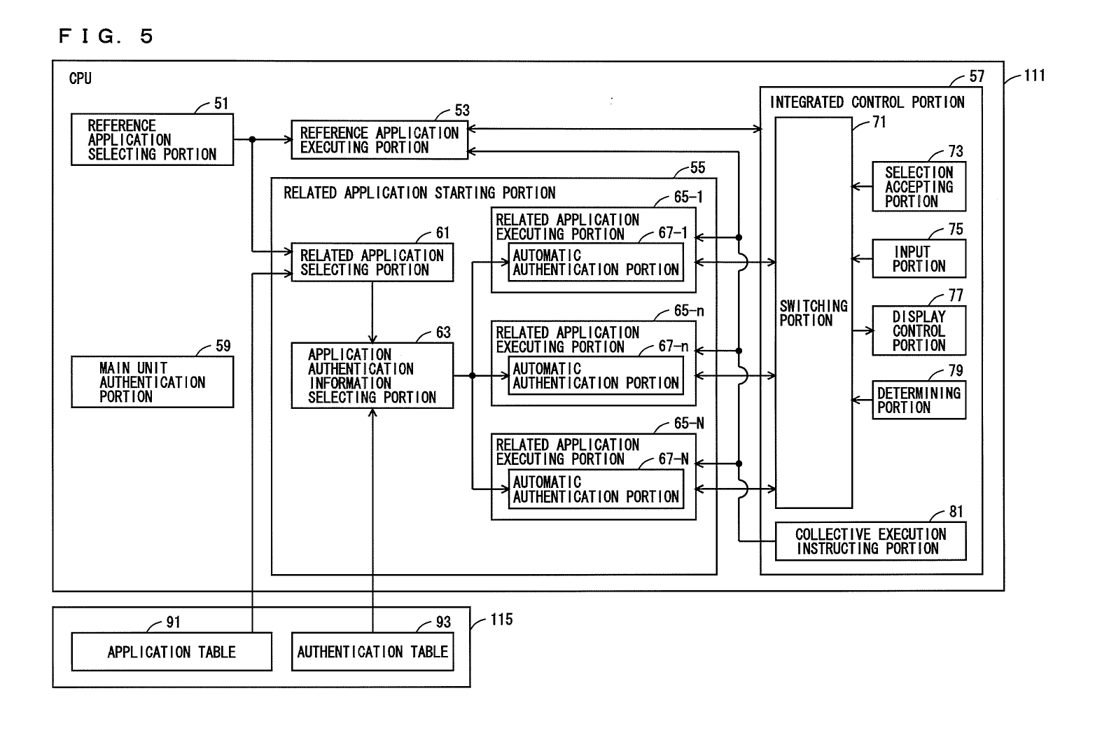

FIG. 5 is a block diagram schematically showing the functions of a CPU included in the MFP, together with information stored in the EEPROM. The functions of CPU 111 shown in FIG. 5 are implemented as CPU 111 executes a browsing program and a communication control program stored in ROM 113, EEPROM 115, HDD 116, or CD-ROM 119A.

Referring to FIG. 5, an application table 91 and an authentication table 93 are stored in EEPROM 115 in advance. Application table 91 stores application information about the application programs installed in MFP 100. Application table 91 and authentication table 93 will now be described.

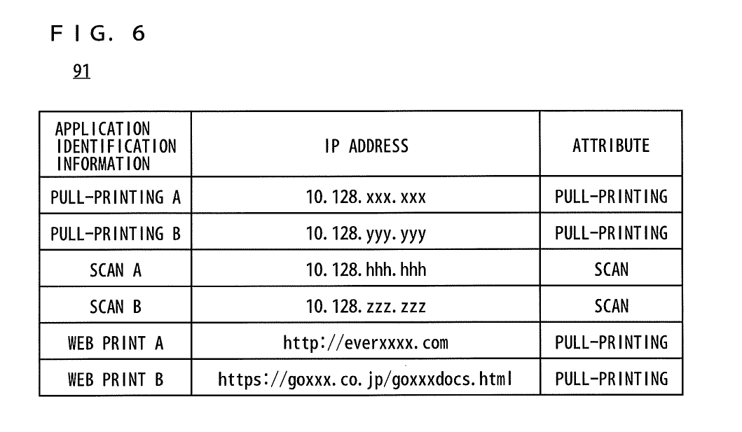

FIG. 6 shows an example of the application table. Referring to FIG. 6, application table 91 includes application records corresponding respectively to a plurality of application programs. Each application record includes an “application identification information” field, an “IP address” field, and an “attribute” field. In the “application identification information” field, application identification information for identifying the application program is set. In the “IP address” field, an IP address for a device that provides a service corresponding to the application program is set. Specifically, an IP address for one of servers 300 and 300A to 300D and Web servers 400 and 400A to 400D is set. In the “attribute” field, the type of the application program is set. The type of an application program is the type of a service received therefrom, which here includes pull-printing attribute, scan attribute, and internet web server (IWS) attribute. While it is here assumed that the type of an application program is the type of that service which is provided as a result of execution of the application program, it may be a group that is set by a user in advance. A user is able to set a plurality of application programs which provide different services, to a same type (or, group).

Application table 91 shown in FIG. 6 corresponds to the case where six application programs have been installed and, thus, includes six application records. Referring to FIG. 6, for the application record with “pull-printing A” being set in the “application identification information” field, “10.128.xxx.xxx” is set in the “IP address” field, and “pull-printing” is set in the “attribute” field.

It is here assumed that server 300 has an IP address of “10.128.xxx.xxx”. The record thus shows that the application program with the application identification information “pull-printing A” is an application program which receives a pull-printing service from server 300. The pull-printing service refers to a service of temporarily storing user identification information and print data in association with each other and, when a user logs in on MFP 100, transmitting to MFP 100 the print data associated with the user identification information of the logged-in user.

There are three more application records having the same attribute, “pull-printing”, set in the “attribute” field: those with “pull-printing B”, “Web print A”, and “Web print B” set in the “application identification information” field. The respective records show that the application program with the application identification information “pull-printing B” is an application program which receives a pull-printing service from server 300A, that the application program with the application identification information “Web print A” is an application program which receives a pull-printing service from Web server 400, and that the application program with the application identification information “Web print B” is an application program which receives a pull-printing service from Web server 400A.

Further, for the application record with “scan A” being set in the “application identification information” field, “10.128.hhh.hhh” is set in the “IP address” field, and “scan” is set in the “attribute” field. It is here assumed that server 300B has an IP address of “10.128.hhh.hhh”. The record thus shows that the application program with the application identification information “scan A” is an application program which receives a scan-to-box service from server 300B. The scan-to-box service refers to a service of storing image data which is obtained by scanning a document in MFP 100 and user identification information of a user who has logged in on MFP 100 in association with each other, in a HDD included in server 300B. There is one more application record having the same attribute, “scan”, set in the “attribute” field: the one with “scan B” set in the “application identification information” field. The record shows that the application program with the application identification information “scan B” is an application program which receives a scan-to-box service from server 300C.

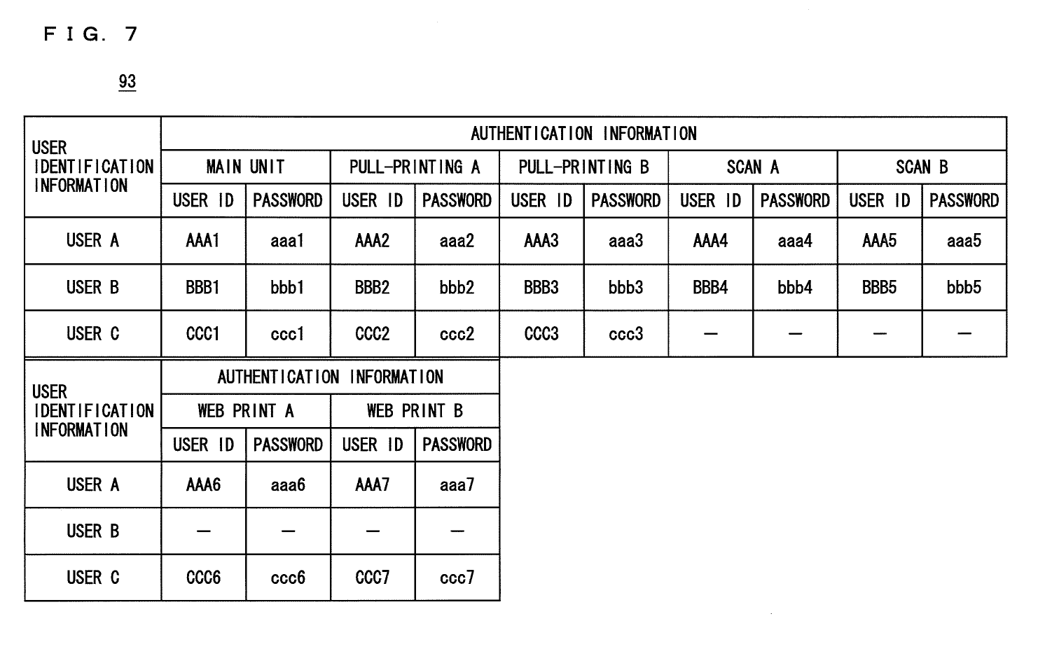

FIG. 7 shows an example of the authentication table. Authentication table 93 specifies, for each of at least one user who has been permitted to use MFP 100, authentication information for use in a main unit authentication in MFP 100, and authentication information for each of a plurality of application programs installed in MFP 100. Referring to FIG. 7, authentication table 93 includes authentication records for three users. Each authentication record includes a “user identification information” field and an “authentication information” field. The “authentication information” field includes a “main unit” field in which authentication information for MFP 100 is set, a “pull-printing A” field in which authentication information for an application program with the application identification information “pull-printing A” is set, a “pull-printing B” field in which authentication information for an application program with the application identification information “pull-printing B” is set, a “scan A” field in which authentication information for an application program with the application identification information “scan A” is set, a “scan B” field in which authentication information for an application program with the application identification information “scan B” is set, a “Web print A” field in which authentication information for an application program with the application identification information “Web print A” is set, and a “Web print B” field in which authentication information for an application program with the application identification information “Web print B” is set. Each piece of authentication information includes a “user ID” field and a “password” field.

The user having the user identification information “user A” is permitted to use the main unit and all the application programs. Therefore, the authentication information is set for each of the main unit and all the application programs. For the user with the user identification information “user B”, the authentication information is set for the main unit and for each of the application programs other than those with the application identification information “Web print A” and “Web print B”. For the user with the user identification information “user C”, the authentication information is set for the main unit and for each of the application programs other than those with the application identification information “scan A” and “scan B”.

Returning to FIG. 5, CPU 111 includes: a reference application selecting portion 51 which selects a reference application program; a reference application executing portion 53 which executes the reference application program; a related application starting portion 55 which starts a related application program, the related application program being an application program that is of the same type as the reference application program; an integrated control portion 57 which selectively switches input/output between the reference application program and the related application program; and a main unit authentication portion 59.

Main unit authentication portion 59 authenticates a user who operates MFP 100. Main unit authentication portion 59 displays an authentication screen on display portion 103, and accepts a user ID and a password which the user inputs to operation portion 105. Main unit authentication portion 59 refers to authentication table 93 which has been stored in EEPROM 115 in advance, to determine whether a set of the user ID and the password input to operation portion 105 is registered in authentication table 93. Main unit authentication portion 59 authenticates the user provided that the set of the user ID and the password input to operation portion 105 is registered in authentication table 93; otherwise, main unit authentication portion 59 does not authenticate the user.

Specifically, when a user with the user identification information “user A” inputs a user ID “AAA1” and a password “aaa1” to operation portion 105, main unit authentication portion 59 extracts, from among authentication records stored in authentication table 93, an authentication record including the user ID “AAA1” which has been input to operation portion 105. Then, main unit authentication portion 59 acquires, from the extracted authentication record, the set of the user ID “AAA1” and the password “aaa1” set in the “main unit” field in the “authentication information” field, and compares the acquired set with the set of the user ID “AAA1” and the password “aaa1” which has been input to operation portion 105, to thereby authenticate the user.

CPU 111 handles any operation input to operation portion 105, from when a user is authenticated by main unit authentication portion 59 till when a logout operation is input, as an operation that is input by the user authenticated by main unit authentication portion 59. Hereinbelow, it is assumed that main unit authentication portion 59 has authenticated the user with the user identification information “user A”.

When the user designates application key 105B included in operation portion 105, reference application selecting portion 51 displays an application selecting screen on display portion 103, and accepts from the user an instruction to start an application program. The application selecting screen has designation buttons to each of which a command for executing a corresponding one of a plurality of application programs stored in EEPROM 115 is assigned. Reference application selecting portion 51 refers to authentication table 93 to determine one or more application programs for which authentication information has been registered for the user who is identified by the user ID of the user authenticated by main unit authentication portion 59. Reference application selecting portion 51 then generates an application selecting screen including one or more designation buttons to each of which a command for executing a corresponding one of the determined application program(s) is assigned. When one of the button(s) included in the application selecting screen is designated, reference application selecting portion 51 outputs the application identification information for identifying the application program associated with the designated designation button, to reference application executing portion 53 and related application starting portion 55.

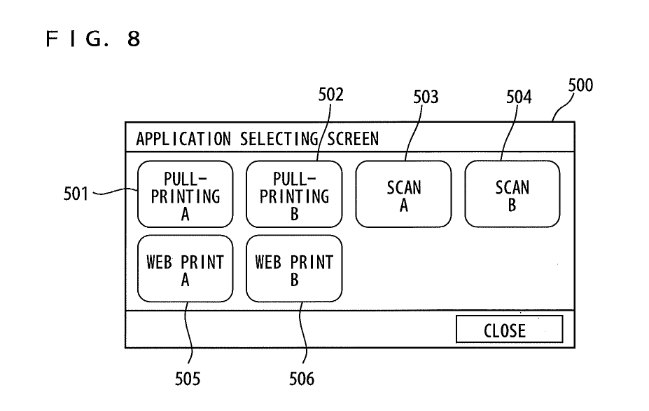

FIG. 8 shows an example of the application selecting screen. Referring to FIG. 8, an application selecting screen 500 includes six designation buttons 501 to 506 having application identification information displayed thereon. For example, designation button 501 is associated with a command for executing the application program with the application identification information “pull-printing A”. Therefore, when a user designates designation button 501, CPU 111 accepts an instruction to start the application program. It is here assumed that designation button 501 is selected on application selecting screen 500 shown in FIG. 8.

Returning to FIG. 5, when designation button 501 is selected on application selecting screen 500, reference application selecting portion 51 outputs the application identification information “pull-printing A” to reference application executing portion 53 and related application starting portion 55. In response to an input of the application identification information “pull-printing A” from reference application selecting portion 51, reference application executing portion 53 selects, from among a plurality of application programs stored in EEPROM 115, an application program specified by the application identification information “pull-printing A” input from reference application selecting portion 51, and executes the same. Hereinbelow, the application program that is specified by the application identification information (“pull-printing A”) input from reference application selecting portion 51 will be referred to as a “reference application program”. Reference application executing portion 53 is a task which is generated in CPU 111 as CPU 111 executes a reference application program. Reference application executing portion 53 inputs data from and outputs data to integrated control portion 57, which will be described later.

Reference application executing portion 53 extracts, from among authentication records stored in authentication table 93, an authentication record including the user identification information “user A” of the user who has been authenticated by main unit authentication portion 59. Then, reference application executing portion 53 acquires a set of the user ID and the password that is associated by the extracted authentication record with the application identification information “pull-printing A” input from reference application selecting portion 51, and uses the acquired set of the user ID “AAA2” and the password “aaa2” to authenticate the user, determining that the user has been permitted to execute the application program specified by the application identification information “pull-printing A”. Reference application executing portion 53 continues to execute the reference application program provided that the user is determined to be the one permitted to execute the application program specified by the application identification information “pull-printing A”. Reference application executing portion 53 terminates the reference application program if it determines that the user is not permitted to execute the application program specified by the application identification information “pull-printing A”.

Further, reference application executing portion 53 may communicate with one of servers 300 and 300A to 300D and Web servers 400 and 400A to 400D via network I/F 118 so as to receive a service therefrom. In order for reference application executing portion 53 to receive a service by communicating with one of servers 300 and 300A to 300D and Web servers 400 and 400A to 400D, an authentication may be required for receiving the service. Here, the application program specified by the application identification information “pull-printing A” which is to be executed by reference application executing portion 53 is an application program that receives a pull-printing service from server 300. Therefore, reference application executing portion 53 transmits the authentication information, which is made up of the set of the user ID “AAA2” and the password “aaa2”, to server 300 via network I/F 118, to cause server 300 to perform an authentication. It is noted that server 300 uses the authentication information made up of the set of the user ID “AAA2” and the password “aaa2” to perform the authentication, and if the authentication is successful, server 300 transmits a list of print data to MFP 100.

Related application starting portion 55 includes: a related application selecting portion 61 which selects a related application program; an application authentication information selecting portion 63; and related application executing portions 65-1 to 65-N each configured to execute a selected application program.

Related application selecting portion 61 receives application identification information from reference application selecting portion 51. When the application identification information “pull-printing A” is input from reference application selecting portion 51, related application selecting portion 61 refers to application table 91 to select, as a related application program, an application program that is of the same type as the application program identified by the application identification information “pull-printing A” input from reference application selecting portion 51. When there is more than one application program which is of the same type as the application program identified by the application identification information “pull-printing A” input from reference application selecting portion 51, related application selecting portion 61 selects all of those application programs as the related application programs. Referring to application table 91 shown in FIG. 6, the application record with the application identification information “pull-printing A” has “pull-printing” set in the “attribute” field. In this table, three other application records having “pull-printing B”, “Web print A”, and “Web print B” set in the “application identification information” field have “pull-printing” set in the “attribute” field. Therefore, related application selecting portion 61 selects the three application programs with the application identification information “pull-printing B”, “Web print A”, and “Web print B”, respectively, as the related application programs.

Related application selecting portion 61 outputs related application identification information for identifying the selected related application program to application authentication information selecting portion 63. In the case where related application selecting portion 61 has selected a plurality of related application programs, related application selecting portion 61 outputs to application authentication information selecting portion 63 a plurality of pieces of related application identification information for identifying the respective related application programs. It is here assumed that N related application programs (where N is an integer of 2 or greater) have been selected.

Application authentication information selecting portion 63 receives N pieces of related application identification information from related application selecting portion 61. Application authentication information selecting portion 63 extracts, from among authentication records stored in authentication table 93, an authentication record that includes the user identification information of the user who has been authenticated by main unit authentication portion 59. Then, application authentication information selecting portion 63 acquires, from within the extracted authentication record, a set of user ID and password corresponding to each of the N pieces of application identification information input from related application selecting portion 61.

Further, application authentication information selecting portion 63 starts, among the application programs stored in EEPROM 115, related application programs which are specified respectively by the N pieces of related application identification information input from related application selecting portion 61. In the case where the authentication record extracted from authentication table 93 includes no authentication information corresponding to the application identification information input from related application selecting portion 61, then application authentication information selecting portion 63 does not start the related application program that is identified by that application identification information for which no authentication information has been set.

When starting a related application program, application authentication information selecting portion 63 passes a set of user ID and password corresponding to the started related application program, as arguments, to a task of executing the related application program. As a result, the set of the user ID and the password corresponding to the related application program is input to the task of CPU 111 that executes the related application program.

Application authentication information selecting portion 63 starts the related application programs that are specified respectively by the N pieces of related application identification information input from related application selecting portion 61. This causes related application executing portions 65-1 to 65-N to be formed in CPU 111. Here, related application executing portions 65-1 to 65-N are tasks that are formed in CPU 111 as the N related application programs are executed. Each of related application executing portions 65-1 to 65-N inputs data from and outputs data to integrated control portion 57, which will be described later. Here, the three application programs with the application identification information “pull-printing B”, “Web print A”, and “Web print B” are selected as the related application programs, whereby N=3. Related application executing portion 65-1 is formed as a task of executing the application program with the application identification information “pull-printing B”, related application executing portion 65-2 is formed as a task of executing the application program with the application identification information “Web print A”, and related application executing portion 65-3 is formed as a task of executing the application program with the application identification information “Web print B”.

It is noted that related application executing portion 65-n (where n is an integer of not smaller than 2 and not greater than (N−1)) shown in FIG. 5 represents related application executing portions 65-2 to 65-(N−1). Further, in the case where a single related application program is selected by related application selecting portion 61, related application executing portion 65-n and related application executing portion 65-N are not formed in CPU 111. Furthermore, in the case where two related application programs are selected by related application selecting portion 61, N=2, and accordingly, related application executing portion 65-n is not formed in CPU 111.

Related application executing portions 65-1 to 65-N are identical in basic functions; they only differ in related application programs executed thereby. Therefore, related application executing portion 65-1 will now be described representatively. Related application executing portion 65-1 includes an automatic authentication portion 67-1. Automatic authentication portion 67-1 receives a set of user ID and password from application authentication information selecting portion 63. Automatic authentication portion 67-1 uses the user ID and the password input from application authentication information selecting portion 63 to determine whether the user is permitted to execute the related application program. User IDs and passwords of users who are permitted to execute the application program which is specified by the related application identification information are stored in advance, and it is determined whether the set of the user ID and the password input from application authentication information selecting portion 63 matches any of the sets of the user IDs and the passwords stored in advance. Provided that automatic authentication portion 67-1 determines that the user is permitted to execute the related application program specified by the related application identification information, related application executing portion 65-1 continues to execute the related application program. When automatic authentication portion 67-1 determines that the user is not permitted to execute the related application program specified by the related application identification information, related application executing portion 65-1 terminates the related application program. A user needs to input only the user ID and the password for an authentication by main unit authentication portion 59. This simplifies the user's operation for authentication.

Further, when related application executing portion 65-1 is to communicate with one of servers 300 and 300A to 300D and Web servers 400 and 400A to 400D in order to receive a service therefrom, an authentication may be required for receiving the service. Automatic authentication portion 67-1 causes the one of servers 300 and 300A to 300D and Web servers 400 and 400A to 400D, from which the service is to be received, to perform the authentication via network I/F 118. Here, as the task of executing the application program with the application identification information “pull-printing B”, related application executing portion 65-1 receives the user ID “AAA3” and the password “aaa3” from application authentication information selecting portion 63. Automatic authentication portion 67-1 transmits the authentication information made up of the user ID “AAA3” and the password “aaa3” to server 300A via network I/F 118, to cause server 300A to authenticate the user. If the authentication in server 300A is successful, server 300A transmits a list of print data to related application executing portion 65-1.

Integrated control portion 57 selects one of reference application executing portion 53 and related application executing portions 65-1 to 65-N and connects the selected portion to display portion 103 and operation portion 105 which provide an interface with a user. Specifically, integrated control portion 57 displays on display portion 103 data that is output from the selected one of reference application executing portion 53 and related application executing portions 65-1 to 65-N, and outputs a user's operation input into operation portion 105, to the selected one of reference application executing portion 53 and related application executing portions 65-1 to 65-N.

Integrated control portion 57 includes a switching portion 71, a selection accepting portion 73, an input portion 75, a display control portion 77, a determining portion 79, and a collective execution instructing portion 81. Input portion 75 is connected to operation portion 105, and accepts an operation input by a user to operation portion 105 and outputs the accepted operation to switching portion 71. Display control portion 77 controls display portion 103 to cause it to display data output from switching portion 71.

Switching portion 71 receives data which is output from each of reference application executing portion 53 and related application executing portions 65-1 to 65-N. Switching portion 71 outputs the data output from each of related application executing portions 65-1 to 65-N, to determining portion 79.

Determining portion 79 analyzes the data output from each of related application executing portions 65-1 to 65-N to determine whether there is data to be processed. Determining portion 79 then outputs to switching portion 71 application identification information corresponding to any of related application executing portions 65-1 to 65-N that includes no data to be processed. For example, related application executing portion 65-1 receives a pull-printing service provided from server 300A. Therefore, determining portion 79 determines whether server 300A stores therein the print data corresponding to the user identification information “user A” of the logged-in user. At the time point when a logged-in user is authenticated by automatic authentication portions 67-1, if server 300A stores therein the print data associated with that authenticated user, then server 300A returns to MFP 100 a list of file names as the information for identifying the print data. Determining portion 79 analyzes the list returned from server 300A to determine whether there is the print data to be processed. If the list retuned from server 300A includes a file name as the information for identifying the print data, it is determined that there is the print data to be processed; otherwise, it is determined that there is no print data to be processed. If there is no print data to be processed, determining portion 79 outputs to switching portion 71 a data missing signal that includes the application identification information “pull-printing B” of the related application program corresponding to related application executing portion 65-1.

In the case where a data missing signal is input from determining portion 79, switching portion 71 selects, as a process target, related application executing portions 65-1 to 65-N excluding the one that corresponds to the application identification information included in the data missing signal. In other words, switching portion 71 selects, as the process targets, only the ones that include data to be processed from among related application executing portions 65-1 to 65-N. It is here assumed that related application executing portions 65-1 to 65-M (where M is an integer of not smaller than 2 and not greater than N) are selected as the process targets, from among related application executing portions 65-1 to 65-N.

Of related application executing portions 65-1 to 65-N, only those including data to be processed are selected as the process targets, the rest being excluded from the process target. This allows only the necessary data to be displayed to a user. Further, the load of CPU 111 may decrease if a process is terminated on any of related application executing portions 65-1 to 65-N that includes no data to be processed.

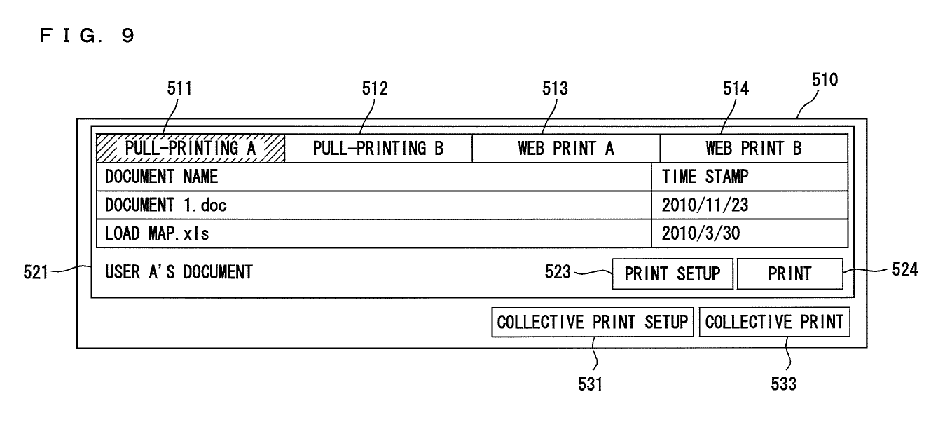

Display control portion 77 generates an integrated screen and causes display portion 103 to display the integrated screen. FIG. 9 shows an example of the integrated screen. The integrated screen in FIG. 9 is displayed when the application program with the application identification information “pull-printing A” is selected as a reference application program and the application programs with the application identification information “pull-printing B”, “Web print A”, and “Web print B” are selected as related application programs.

Referring to FIG. 9, an integrated screen 510 includes select buttons 511 to 514, a selected application displaying area 521, and collective instruction buttons 531 and 533. Select button 511 is a button that includes the application identification information “pull-printing A” and is used for selecting reference application executing portion 53 which is the task of executing the reference application program with the application identification information “pull-printing A”. Select button 512 is a button that includes the application identification information “pull-printing B” and is used for selecting related application executing portion 65-1 which is the task of executing the related application program with the application identification information “pull-printing B”. Select button 513 is a button that includes the application identification information “Web print A” and is used for selecting related application executing portion 65-2 which is the task of executing the related application program with the application identification information “Web print A”. Select button 514 is a button that includes the application identification information “Web print B” and is used for selecting related application executing portion 65-3 which is the task of executing the related application program with the application identification information “Web print B”. In FIG. 9, the hatch pattern indicates that select button 511 has been selected.

Selection accepting portion 73, switching portion 71, display control portion 77, and collective execution instructing portion 81 will now be described with reference to integrated screen 510 shown in FIG. 9.

Selected application displaying area 521 is an area for displaying an image of data that is output from that one of reference application executing portion 53 and related application executing portions 65-1 to 65-3 which is specified by a selected one of select buttons 511 to 514. It is here assumed that select button 511 is selected, and accordingly, an image of data output from reference application executing portion 53 corresponding to select button 511 is displayed. Buttons 523 and 524 are included in the data output from reference application executing portion 53.

When a user operates operation portion 105 to designate one of select buttons 511 to 514 included in integrated screen 510 displayed on display portion 103, selection accepting portion 73 accepts the designation. Selection accepting portion 73 outputs the application identification information associated with the designated one of select buttons 511 to 514, to switching portion 71.

In the state where no application identification information has been input from selection accepting portion 73, switching portion 71 outputs to display control portion 77 the data output from reference application executing portion 53, and outputs to reference application executing portion 53 an instruction output from input portion 75. When application identification information is input from selection accepting portion 73, switching portion 71 outputs to display control portion 77 the data which is output from that one of reference application executing portion 53 and related application executing portions 65-1 to 65-3 which is identified by the application identification information input from selection accepting portion 73, and outputs the instruction output from input portion 75, to that one of reference application executing portion 53 and related application executing portions 65-1 to 65-3 which is identified by the application identification information input from selection accepting portion 73.

Display control portion 77 displays an image of the data input from switching portion 71, on selected application displaying area 521 in integrated screen 510. In integrated screen 510 shown in FIG. 9, select button 511 has been designated, and an image of the data output from reference application executing portion 53 is displayed on selected application displaying area 521 in integrated screen 510. In this state, when a user inputs to operation portion 105 an operation of designating one of buttons 523 and 524 included in selected application displaying area 521 in integrated screen 510, input portion 75 accepts the operation of designating one of buttons 523 and 524, and outputs the same to switching portion 71. Switching portion 71 outputs the operation input from input portion 75, to reference application executing portion 53 corresponding to select button 511.

Further, in the state where integrated screen 510 shown in FIG. 9 is being displayed on display portion 103, when a user operates operation portion 105 to designate select button 512, for example, from among select buttons 511 to 514, then selection accepting portion 73 outputs the application identification information “pull-printing B” which is associated with select button 512 to switching portion 71. When switching portion 71 receives the application identification information “pull-printing B” from selection accepting portion 73, switching portion 71 outputs the data output from related application executing portion 65-1, to display control portion 77. Display control portion 77 displays an image of the data output from related application executing portion 65-1, on selected application displaying area 521. When a user inputs an operation to operation portion 105 in accordance with the screen being displayed on selected application displaying area 521, input portion 75 accepts the operation, and outputs the same to switching portion 71. Switching portion 71 outputs the operation input from input portion 75, to related application executing portion 65-1 corresponding to select button 512.

As described above, a user can select one of reference application executing portion 53 and related application executing portions 65-1 to 65-3 by selecting the corresponding one of select buttons 511 to 514 displayed on display portion 103. Further, a user can input an operation to the selected one of reference application executing portion 53 and related application executing portions 65-1 to 65-3 by inputting the operation to operation portion 105 in accordance with the screen being displayed on selected application displaying area 521.

Collective instruction buttons 531 and 533 included in integrated screen 510 shown in FIG. 9 are buttons for outputting an instruction common to all of reference application executing portion 53 and related application executing portions 65-1 to 65-3. When collective instruction button 531 is designated, collective execution instructing portion 81 accepts a collective setting instruction. When collective instruction button 533 is designated, collective execution instructing portion 81 accepts a collective printing instruction. When accepting the collective setting instruction, collective execution instructing portion 81 displays a print setup screen on display portion 103, and accepts printing conditions which a user inputs into the print setup screen. Collective execution instructing portion 81 outputs the accepted printing conditions to all of reference application executing portion 53 and related application executing portions 65-1 to 65-3, to cause them to set the printing conditions. Accordingly, a single set of operations of designating collective instruction button 531 and setting printing conditions can cause the common printing conditions to be set in all of reference application executing portion 53 and related application executing portions 65-1 to 65-3.

When collective execution instructing portion 81 accepts the collective printing instruction, collective execution instructing portion 81 outputs a printing instruction to each of reference application executing portion 53 and related application executing portions 65-1 to 65-3. When receiving the printing instruction, reference application executing portion 53 and related application executing portions 65-1 to 65-3 receive print data from server 300, server 300A, Web server 400, and Web server 400A, respectively, to perform a print process. Accordingly, a single operation of designating collective instruction button 533 can cause all of reference application executing portion 53 and related application executing portions 65-1 to 65-3 to perform the processing.

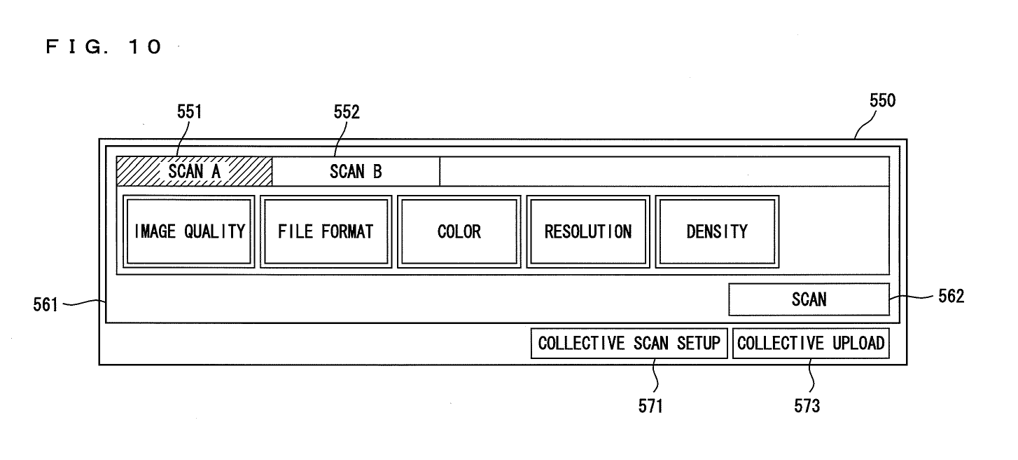

FIG. 10 shows another example of the integrated screen. The integrated screen in FIG. 10 is displayed when the application program with the application identification information “scan A” is selected as a reference application program and the application program with the application identification information “scan B” is selected as a related application program.

Referring to FIG. 10, an integrated screen 550 includes select buttons 551 and 552, a selected application displaying area 561, and collective instruction buttons 571 and 573. Select button 551 is a button that includes the application identification information “scan A” and is used for selecting reference application executing portion 53 which is the task of executing the reference application program with the application identification information “scan A”. Select button 552 is a button that includes the application identification information “scan B” and is used for selecting related application executing portion 65-1 which is the task of executing the related application program with the application identification information “scan B”. In FIG. 10, the hatch pattern indicates that select button 551 has been selected.

In the state where integrated screen 550 shown in FIG. 10 is being displayed on display portion 103, when a user operates operation portion 105 to designate select button 552, selection accepting portion 73 outputs the application identification information “scan B” which is associated with select button 552, to switching portion 71. When receiving the application identification information “scan B” from selection accepting portion 73, switching portion 71 outputs the data that is output from related application executing portion 65-1, which is the task of executing the related application program specified by the application identification information “scan B”, to display control portion 77. Display control portion 77 displays an image of the data output from related application executing portion 65-1, on selected application displaying area 561. When a user inputs an operation to operation portion 105 in accordance with the screen being displayed on selected application displaying area 561, input portion 75 accepts the operation, and outputs the same to switching portion 71. Switching portion 71 outputs the operation input from input portion 75, to related application executing portion 65-1.

As described above, a user can select one of reference application executing portion 53 and related application executing portion 65-1 by selecting the corresponding one of select buttons 551 and 552 displayed on display portion 103. Further, a user can input an operation to the selected one of reference application executing portion 53 and related application executing portion 65-1 by inputting the operation to operation portion 105 in accordance with the screen being displayed on selected application displaying area 561.

Collective instruction buttons 571 and 573 included in integrated screen 550 shown in FIG. 10 are buttons for outputting a common instruction to reference application executing portion 53 and related application executing portion 65-1. When collective instruction button 571 is designated, collective execution instructing portion 81 accepts a collective setting instruction. When collective instruction button 573 is designated, collective execution instructing portion 81 accepts a collective uploading instruction. When accepting the collective setting instruction, collective execution instructing portion 81 displays a scan setting screen on display portion 103, and accepts scanning conditions which a user inputs into the scan setting screen. Collective execution instructing portion 81 outputs the accepted scanning conditions to both of reference application executing portion 53 and related application executing portion 65-1 to cause them to set the scanning conditions. Accordingly, a single set of operations of designating collective instruction button 571 and setting scanning conditions can cause the common scanning conditions to be set in both of reference application executing portion 53 and related application executing portion 65-1.

When collective execution instructing portion 81 accepts the collective uploading instruction, collective execution instructing portion 81 outputs a scanning instruction to both of reference application executing portion 53 and related application executing portion 65-1. When receiving the scanning instruction, reference application executing portion 53 and related application executing portion 65-1 control document reading portion 20 to cause it to read a document and output image data to reference application executing portion 53 and related application executing portion 65-1, respectively. Reference application executing portion 53 transmits the image data to server 300B from which it will receive a service, while related application executing portion 65-1 transmits the image data to server 300C from which it will receive a service. Accordingly, a single operation of designating collective instruction button 573 can cause both of reference application executing portion 53 and related application executing portion 65-1 to perform the processing. It is noted that document reading portion 20 performs a single scan on the basis of the instruction from each of reference application executing portion 53 and related application executing portion 65-1, and outputs the image data to each of reference application executing portion 53 and related application executing portion 65-1.

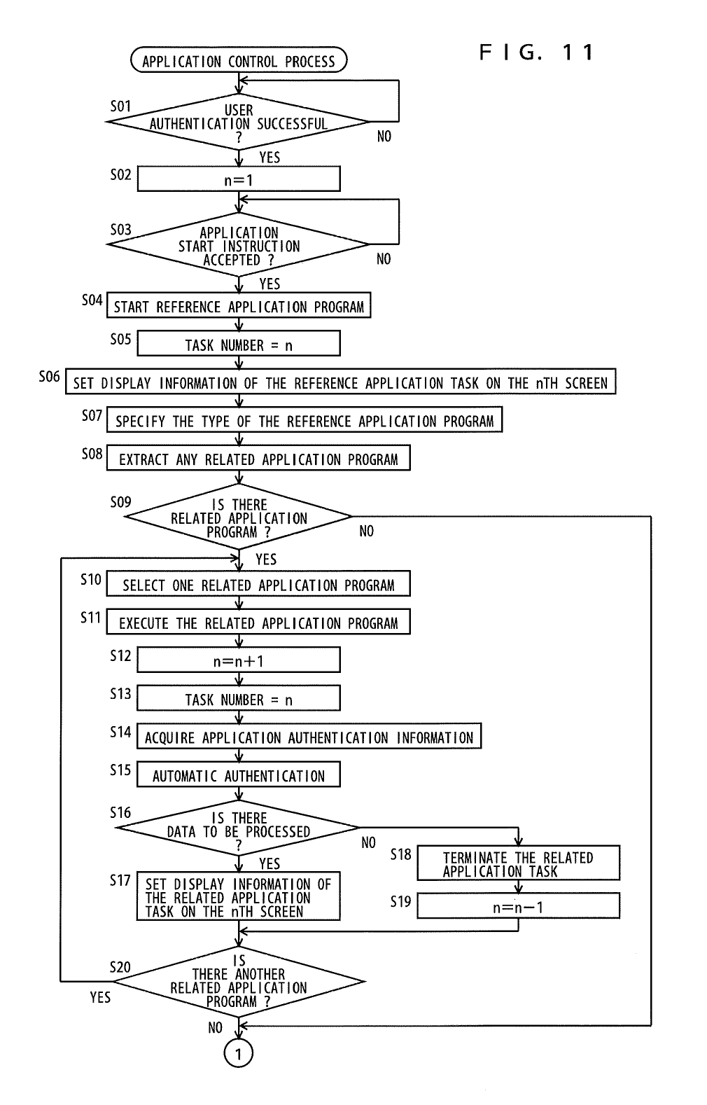

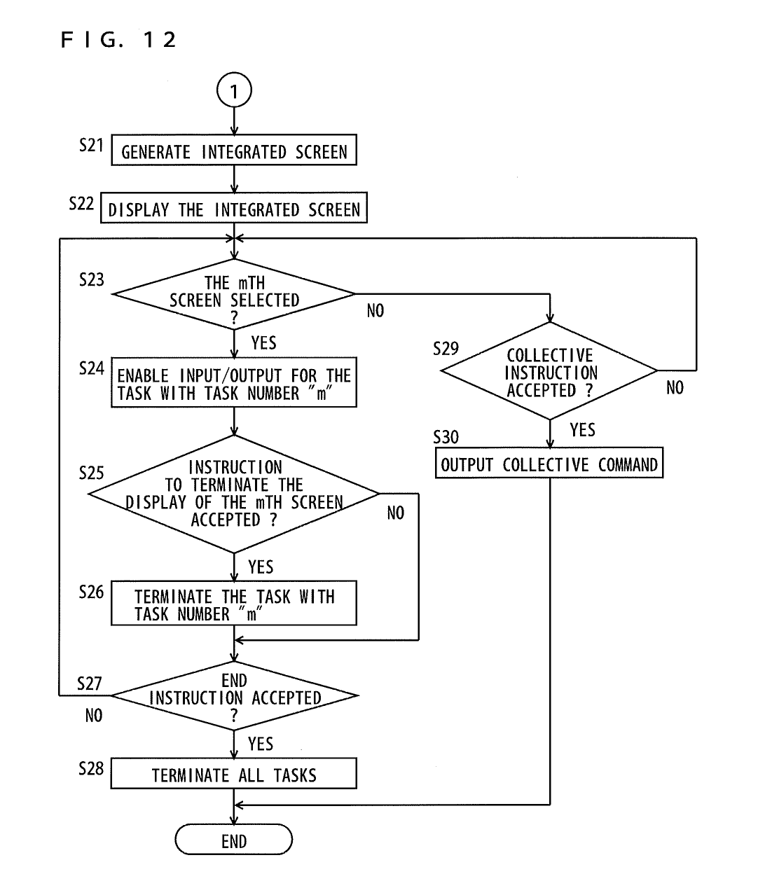

FIGS. 11 and 12 show a flowchart illustrating an example of the flow of an application control process. The application control process is carried out by CPU 111 included in MFP 100 as CPU 111 executes an application control program stored in ROM 113, EEPROM 115, HDD 116, or CD-ROM 119A.

Referring to FIGS. 11 and 12, CPU 111 determines whether user authentication has been successful (step S01). CPU 111 is in a standby mode until the user authentication is successful (“NO” in step S01), and once the user authentication has been successful (“YES” in step S01), the process proceeds to step S02. When a user inputs a user ID and a password to operation portion 105, if authentication table 93 stored in advance in EEPROM 115 includes a set of the user ID and the password identical to the input set of the user ID and the password, then CPU 111 determines that the user authentication is successful.

In the following step S02, a variable n is set to “1”, and the process proceeds to step S03. The variable n is a value for specifying the task of executing an application program as a process target. In the following step S03, CPU 111 determines whether an instruction to start an application program has been accepted. When a user designates application key 105B included in operation portion 105, an application selecting screen is displayed on display portion 103. Then, when the user designates a designation button which is included in the application selecting screen and which is associated with a command for executing a corresponding one of a plurality of application programs stored in EEPROM 115, CPU 111 accepts an instruction to start the application program which is associated with the designation button designated by the user.

CPU 111 is in a standby mode until the instruction to start an application program is accepted (“NO” in step S03), and once the instruction has been accepted (“YES” in step S03), the process proceeds to step S04. In step S04, CPU 111 executes the reference application program that is specified by the instruction to start the application program. As CPU 111 executes the reference application program, a task is formed in CPU 111. Hereinafter, the task which is formed in CPU 111 as CPU 111 executes the reference application program will be referred to as a “reference application task”.

In the following step S05, a task number is set to the value that has been assigned to the variable n. The task number is information for identifying a task that is to be processed when CPU 111 executes the application control process. In the following step S06, display information of the reference application task is set on the nth screen. The display information of the reference application task is an image which is generated on the basis of data output from the reference application task. In the following step S07, CPU 111 specifies the type of the reference application program. The type of the reference application program is specified by a group into which the reference application program is classified according to predetermined application table 91. It is here assumed that the type of the reference application program is “pull-printing”. In the following step S08, CPU 111 extracts a related application program. Specifically, any application program that has been classified into the same group as the reference application program in application table 91 is extracted as the related application program.

In the following step S09, CPU 111 determines whether a related application program has been extracted. If so, the process proceeds to step S10; otherwise, the process proceeds to step S21. In step S10, CPU 111 selects, from the one or more related application programs extracted in step S08, one related application program as a process target. CPU 111 then executes the related application program selected as the process target (step S11). As CPU 111 executes the related application program which has been selected as the process target, a task is formed in CPU 111. Hereinafter, the task which is formed in CPU 111 as CPU 111 executes a related application program selected as a process target will be referred to as a “related application task”.

In the following step S12, the variable n is incremented by 1, and the process proceeds to step S13. In step S13, the task number is set to the value that has been assigned to the variable n, and the process proceeds to step S14. In step S14, CPU 111 acquires application authentication information. Specifically, CPU 111 refers to authentication table 93 stored in EEPROM 115 to acquire, from among the sets of user IDs and passwords which are associated with the user identification information of the user authenticated in step S01, that set of the user ID and the password which is stored in correspondence with the related application program selected in step S10, as the application authentication information. In the following step S15, CPU 111 performs an automatic authentication process. The related application task, which has been generated as the related application program has been executed in step S11, communicates with one of servers 300 and 300A to 300D and Web servers 400 and 400A to 400D, to receive a service therefrom. It is here assumed that the related application task which is specified by the task number communicates with server 300A to receive a service from server 300A. The application authentication information acquired in step S14 is passed to the related application task to cause it to perform an authentication. Specifically, the related application task transmits the application authentication information via network I/F 118 to server 300A to cause server 300A to authenticate the user. When the user authentication in server 300A is successful, server 300A transmits a list of print data. The related application task receives, via network I/F 118, the list of print data that has been transmitted from server 300A.

In the following step S16, CPU 111 determines whether there is data to be processed by the related application task. Specifically, CPU 111 analyzes the list of print data received from server 300A via network I/F 118 to determine whether there is data to be processed, which is print data here. If there is the data to be processed, the process proceeds to step S17; otherwise, the process proceeds to step S18. In step S17, display information of the related application task that has been generated as a result of execution of the related application program in step S11 is set on the nth screen, and the process proceeds to step S20.

On the other hand, in step S18, the related application task that has been generated as a result of execution of the related application program in step S11 is terminated, and the process proceeds to step S19. In step S19, the variable n is decremented by 1, and the process proceeds to step S20.

In step S20, CPU 111 determines whether there is a related application program which has been extracted in step S08 and which has not been selected as a process target in step S10. If there is a related application program yet to be processed, the process returns to step S10; otherwise, the process proceeds to step S21.

In step S21, CPU 111 generates an integrated screen. The integrated screen is a screen in which the first to nth screens are selectable. The first to nth screens include images of data which are output respectively from the reference application task with the task number “1” and the related application tasks with the task numbers “2” to “n”. The integrated screen includes selectable select buttons which each include application identification information for identifying a corresponding one of the reference application task with the task number “1” and the related application tasks with the task numbers “2” to “n”. The integrated screen further includes a selected application displaying area for displaying therein that one of the first to nth screens which corresponds to the application identification information included in a selected one of the select buttons.

In the following step S22, CPU 111 displays the generated integrated screen on display portion 103. In the following step S23, CPU 111 determines whether the mth screen has been selected. When one of the pieces of application identification information, included in the integrated screen displayed on display portion 103, for respectively identifying the reference application task with the task number “1” and the related application tasks with the task numbers “2” to “n” is selected, CPU 111 determines that the mth screen corresponding to the application program identified by the selected piece of application identification information has been selected. If the mth screen has been selected, the process proceeds to step S24; otherwise, the process proceeds to step S29.

In step S29, CPU 111 determines whether a collective instruction has been accepted. If so, the process proceeds to step S30; otherwise, the process returns to step S23. The collective instruction is an instruction to issue a command common to all of the reference application task with the task number “1” and the related application tasks with the task numbers “2” to “n”. In the case where integrated screen 510 shown in FIG. 9 is displayed, the collective instruction includes a setting instruction which is accepted when collective instruction button 531 is designated, and a printing instruction which is accepted when collective instruction button 533 is designated.

In the following step S30, CPU 111 outputs a collective command to the reference application task with the task number “1” and the related application tasks with the task numbers “2” to “n”, and then terminates the process. In the case where the setting instruction is accepted in step S29, CPU 111 outputs a command for setting the printing conditions which have been set, to each of the reference application task with the task number “1” and the related application tasks with the task numbers “2” to “n”. In the case where the printing instruction is accepted in step S29, CPU 111 outputs a command for printing, to each of the reference application task with the task number “1” and the related application tasks with the task numbers “2” to “n”. The reference application task with the task number “1” and the related application tasks with the task numbers “2” to “n” each perform a print process when it receives the command for printing, and upon completion of the printing, it terminates the process.

On the other hand, in step S24, CPU 111 enables an input to and an output from the task with the task number “m”. That is, CPU 111 controls such that an operation input to operation portion 105 by a user is input to the task with the task number “m” and that an image of data output from the task with the task number “m” is displayed as the mth screen on display portion 103.

In the following step S25, CPU 111 determines whether an instruction to terminate the display of the mth screen has been accepted. If so, the process proceeds to step S26; otherwise, the process proceeds to step S27, with step S26 being skipped. In step S26, CPU 111 terminates the task with the task number “m”, and then the process proceeds to step S27.

In step S27, CPU 111 determines whether an end instruction has been accepted. If so, the process proceeds to step S28; otherwise, the process returns to step S23. The end instruction is accepted as a user presses an end key provided in advance in operation portion 105. In step S28, CPU 111 terminates all the tasks to terminate the application control process.

As described above, MFP 100 according to the present embodiment has a plurality of application programs installed therein, and includes: related application starting portion 55 operable, in response to a start of a reference application program which is an arbitrary one of the plurality of application programs, to start any related application program that is of the same type as the reference application program among the remaining application programs; and integrated control portion 57 to display an integrated screen which displays a first screen and a second screen in a selectable manner, the first screen being output as the reference application program is executed, the second screen being output as the related application program is executed. When an instruction to execute one reference application program is input, one or more related application programs of the same type are executed. This allows a plurality of application programs of the same type to be started with a simple operation.

Further, in the case where MFP 100 is to execute a reference application program whose type is pull-printing, if any of the tasks for executing the related application programs is determined to have no print data to be processed, MFP 100 controls such that a second screen for displaying an image of data output from a task is not displayed for that task having no print data. This allows only the necessary data to be displayed to a user.

Furthermore, the task of executing a related application program is caused to authenticate a user by using the application authentication information which is stored in authentication table 93 in association with the related application program for the user who has logged in on MFP 100. This can simplify the user' operation for authentication.

While MFP 100 has been described as an example of the image forming apparatus in the above embodiment, the present invention may of course be identified as an application control method for causing MFP 100 to perform the application control process shown in FIGS. 11 and 12, or as an application control program for causing a computer to perform the application control method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus having a plurality of application programs installed therein, the apparatus comprising:
a related application starting portion operable, in response to a start of a reference application program which is an arbitrary one of said plurality of application programs, to start at least one related application program which is of the same type as said reference application program among the remaining application programs; and
an integrated display portion to display a first screen and a second screen in a selectable manner, the first screen being output as said reference application program is executed, the second screen being output as said related application program is executed.

2. The image forming apparatus according to claim 1, further comprising a determining portion operable, in the case where the type of said reference application program is pull-printing in which print data is received from a server for printing, to determine, following the execution of said related application program, the presence or absence of print data to be processed by said related application program, wherein
said integrated display portion displays said second screen provided that said determining portion determines that there is the print data to be processed.

3. The image forming apparatus according to claim 2, wherein said determining portion analyzes the second screen output from said related application program to determine the presence or absence of said print data to be processed.

4. The image forming apparatus according to claim 1, wherein
each of said plurality of application programs is classified into one or more of a plurality of groups, and
said related application starting portion includes a selecting portion to select, as the related application program, any application program that is classified into the same group as said reference application program.

5. The image forming apparatus according to claim 1, further comprising:
an authentication table storage portion to store, in advance, an authentication table in which main unit authentication information for use in authenticating a user who is permitted to use the image forming apparatus and a plurality of pieces of application authentication information necessary for corresponding ones of said plurality of application programs are associated with each other;
a main unit authentication portion to authenticate a user using said main unit authentication information; and
an automatic login portion to cause a task of executing said related application program to perform an authentication by using that piece of the application authentication information which is associated with said related application program and also with the user authenticated by said main unit authentication portion.

6. An application control method performed by an image forming apparatus having a plurality of application programs installed therein, the method comprising the steps of:
in response to a start of a reference application program which is an arbitrary one of said plurality of application programs, starting at least one related application program which is of the same type as said reference application program among the remaining application programs; and
displaying a first screen and a second screen in a selectable manner, the first screen being output as said reference application program is executed, the second screen being output as said related application program is executed.

7. The application control method according to claim 6, further comprising the step of, in the case where the type of said reference application program is pull-printing in which print data is received from a server for printing, determining, following the execution of said related application program, the presence or absence of print data to be processed by said related application program, wherein
said displaying step includes a step of displaying said second screen provided that it is determined in said determining step that there is the print data to be processed.

8. The application control method according to claim 7, wherein said determining step includes a step of analyzing the second screen output from said related application program to determine the presence or absence of said print data to be processed.

9. The application control method according to claim 6, wherein
each of said plurality of application programs is classified into one or more of a plurality of groups, and
said step of starting the related application program includes a step of selecting, as the related application program, any application program that is classified into the same group as said reference application program.

10. The application control method according to claim 6, further comprising the steps of:
storing, in advance, an authentication table in which main unit authentication information for use in authenticating a user who is permitted to use the image forming apparatus and a plurality of pieces of application authentication information necessary for corresponding ones of said plurality of application programs are associated with each other;
authenticating a user using said main unit authentication information; and
causing a task of executing said related application program to perform an authentication by using that piece of the application authentication information which is associated with said related application program and also with the user authenticated in said authenticating step.

11. A non-transitory computer-readable recording medium encoded with an application control program performed by a computer which controls an image forming apparatus having a plurality of application programs installed therein,
the program causing said computer to perform the steps of:
in response to a start of a reference application program which is an arbitrary one of said plurality of application programs, starting at least one related application program which is of the same type as said reference application program among the remaining application programs; and
displaying a first screen and a second screen in a selectable manner, the first screen being output as said reference application program is executed, the second screen being output as said related application program is executed.

12. The non-transitory computer-readable recording medium encoded with the application control program according to claim 11, causing said computer to further perform the step of, in the case where the type of said reference application program is pull-printing in which print data is received from a server for printing, determining, following the execution of said related application program, the presence or absence of print data to be processed by said related application program, wherein
said displaying step includes a step of displaying said second screen provided that it is determined in said determining step that there is the print data to be processed.

13. The non-transitory computer-readable recording medium encoded with the application control program according to claim 12, wherein said determining step includes a step of analyzing the second screen output from said related application program to determine the presence or absence of said print data to be processed.

14. The non-transitory computer-readable recording medium encoded with the application control program according to claim 11, wherein
each of said plurality of application programs is classified into one or more of a plurality of groups, and
said step of starting the related application program includes a step of selecting, as the related application program, any application program that is classified into the same group as said reference application program.

15. The non-transitory computer-readable recording medium encoded with the application control program according to claim 11, causing said computer to further perform the steps of:
storing, in advance, an authentication table in which main unit authentication information for authenticating a user who is permitted to use the image forming apparatus and a plurality of pieces of application authentication information necessary for corresponding ones of said plurality of application programs are associated with each other;
authenticating a user using said main unit authentication information; and
causing a task of executing said related application program to perform an authentication by using that piece of the application authentication information which is associated with said related application program and also with the user authenticated in said authenticating step.
